(19) United States
(12) Patent Application Publication
(10) Pub. No.: US 2024/0388911 A1
(43) Pub. Date: Nov. 21, 2024

(54) SYSTEM AND METHOD FOR SECURING COMMUNICATIONS IN AN AREA

(71) Applicant: Verizon Patent and Licensing Inc., Basking Ridge, NJ (US)

(72) Inventors: Bharadwaj Vemuri, Jersey City, NJ (US); Axel Hallo de Wolf, Whippany, NJ (US); Taussif Khan, Martinsville, NJ (US); Manuel Enrique Caceres, Basking Ridge, NJ (US)

(21) Appl. No.: 18/317,258

(22) Filed: May 15, 2023

(51) Int. Cl. H04W 12/086; H04W 12/02; H04W 12/64

(52) U.S. Cl. CPC H04W 12/086; H04W 12/02; H04W 12/64

(57) ABSTRACT

A device may comprise a processor. The processor may be configured to determine, based on secure space information associated with the secure space, whether the device has entered the secure space. If the processor determines that the device has entered the secure space, the processor may disable an ability of the device to communicate wirelessly with networks other than a private network; enable an ability of the device to communicate wirelessly with the private network; connect the device wirelessly to the private network; and run an application hosted on the private network.

### BACKGROUND INFORMATION

Organizations typically implement, for example, firewalls, intrusion detection systems, password protection schemes, encryption, secure protocols, and other schemes to defend against network attacks. However, when a member of an organization has the capability to easily communicate with others outside the organization, the member may also have the capability to capture and exfiltrate sensitive information. Even if the communications were made without malicious intent, a member's mobile device exposes the organization to attempts to obtain unauthorized access to the information through the mobile device.

### BRIEF DESCRIPTION OF THE DRAWINGS

FIG. 1 illustrates concepts described herein;

FIG. 2 illustrates an exemplary network environment in which systems and methods described herein may be implemented;

FIG. 3 depicts an exemplary components of a secure space User Equipment device (UE) according to an implementation;

FIG. 4 illustrates exemplary user profiles that are stored in a secure space UE, according to an implementation;

FIG. 5 shows exemplary views of the display screen of a secure space UE when the UE enters a secure space, according to an implementation;

FIG. 6A illustrates exemplary components of a secure space support system (SSSS) according to an implementation;

FIG. 6B illustrates exemplary components of a virtual machine according to an implementation;

FIG. 7 is a flow diagram of an exemplary process that is associated with a system for securing communications in an area, according to an implementation;

FIG. 8 is a messaging diagram that is associated with a system for securing communications in an area, according to an implementation; and

FIG. 9 depicts exemplary functional components of a network device according to an implementation.

### DETAILED DESCRIPTION OF EXAMPLE EMBODIMENTS

The following detailed description refers to the accompanying drawings. The same reference numbers in different drawings may identify the same or similar elements. As used herein, the terms “service provider” and “provider network” may refer to, respectively, a provider of communication services and a network operated by the service provider. The term “public land mobile network” (PLMN) may refer to a public cellular network. The term “private network” may refer to a cellular network that belongs to an organization (e.g., a government organization, a corporation, an enterprise, etc.). The term “private PLMN” may refer to a private network. A mobile network operator (MNO) that operates a PLMN may manage a private network. As used herein, depending on the context, the term “secure space information” may include a map of an area (e.g., a geofenced area) referred to as a secure space. The map may include data that defines one or more regions or areas in a three-dimensional space and/or a two-dimensional space.

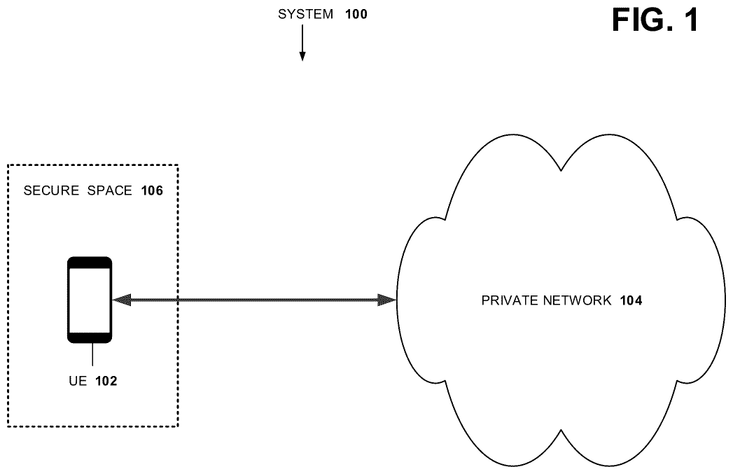

The systems and methods described herein relate to securing communications in an area. In particular, the systems and methods relate to a private cellular network that provides communication services within a predefined geographical area but only to a particular set of authorized User Equipment devices (UEs). FIG. 1 illustrates concepts described herein. As shown, a system 100 may include a secure space User Equipment device (UE) 102 (e.g., a smart phone), one or more components within a private network 104, and a secure space 106. Depending on the implementation, system 100 may include more of secure space UE 102, private network 104 as well as its components, and secure space 106.

Secure space UE 102 (also simply referred to as UE 102) comprises mechanisms for operating securely in secure space 106. Private network 104 includes a secure space support system that handles network services and communications for UE 102 in secure space 106. Secure space 106 is defined by boundaries, in two-dimensional (2D) or three-dimensional (3D) space that UE 102 may recognize. Secure space 106 may include, for example, a piece of land, a building, or another geographical area. When UE 102 enters secure space 106, UE 102 may detect its incursion into secure space 106 and communicate securely over or with private network 104 via devices and/or components in secure space 106.

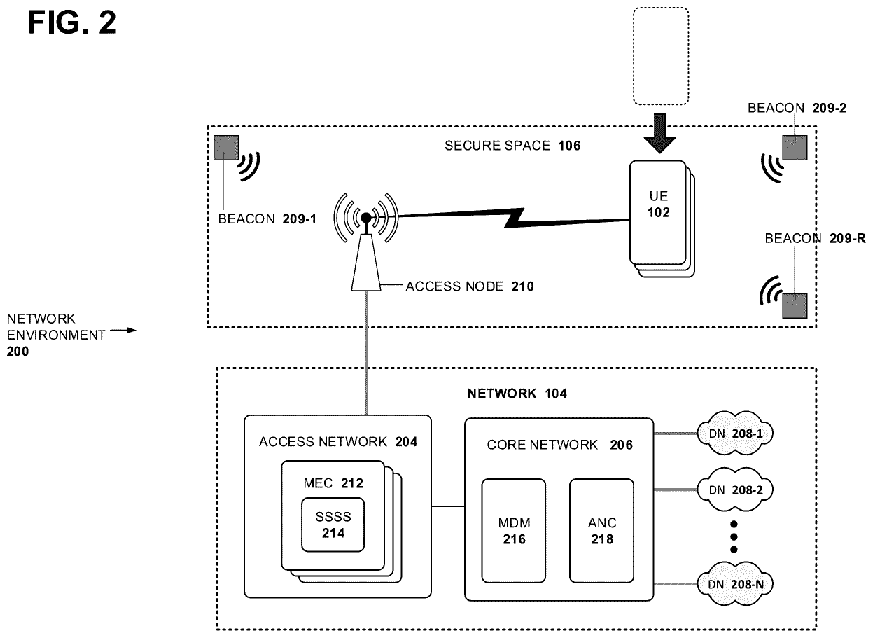

FIG. 2 illustrates an exemplary network environment 200 in which system 100 may be implemented. As shown, network environment 200 may include one or more UEs 102 (individually or generically referred to as UE 102), secure space 106, an access network 204, a core network 206, and data networks (DN) 208-1 through 208-N(collectively referred to as data networks 208 and generically as data network 208). Access network 204, core network 206, and/or data networks 208 may be part of private network 104.

UE 102 may include devices capable of secure communications from within secure space 106. UE 102 may comprise a cellular communication device, such as Fourth Generation (4G) (e.g., Long-Term Evolution (LTE) communication device, a Fifth Generation (5G) New Radio (NR) communication device, and/or a Wi-Fi® communication device. Examples of devices that may be configured to implement UE 102 include: a smart phone; a tablet computer; a wearable computer device (e.g., a smart watch); a global positioning system (GPS) device; a laptop computer; a media playing device; a portable gaming system; an autonomous vehicle navigation system; a sensor, such as a pressure sensor or; and an Internet-of-Things (IoT) device with Wi-Fi® capabilities. In some implementations, such a device may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

UE 102 may include components configured to determine whether UE 102 is in secure space 106. When UE 102 determines that UE 102 has entered secure space 106, UE 102 may connect to private network 104 (via devices in secure space 106, such as access node 210). UE 102 may establish a secure session with components in private network 104, such as a secure space support system (SSSS) 214 in access network 204.

For UE 102 to determine its location in relation to secure space 106, UE 102 may include hardware and software components for receiving location signals from beacons and/or satellites (e.g., a Global Positioning System (GPS) satellites) and for determining, based on the received signals, its current location relative to secure space 106. In some implementations, such hardware and software components may run in the background regardless of the location of UE 102.

In one implementation, when UE 102 enters secure space 106 and detects its entry into secure space 106, UE 102 may terminate its connection to other networks, such as a public network or a Wi-Fi® network, disable further communications with such networks, disable data I/O from/to external devices, and disable onboard applications that have not been certified to be used within secure space 106 (e.g., by the MNO of private network 104). In a different implementation, UE 102 may be configured to operate only in secure space 106. Such UEs 102 may not need to disengage from other devices or networks. In both implementations, after UE 102 enters secure space 106, UE 102 may attach to a device (e.g., an access node 210), which in turn is connected to private network 104 via either a wireless link, an optical link, or a backhaul cable. UE 102 may then communicate over or with private network 104, via the device to which it has attached.

When UE 102 connects to private network 104, UE 102 may authenticate at private network 104 and run secure applications and/or a virtual mobile infrastructure (VMI) client. The VMI client may be configured to obtain sensor inputs (e.g., tactile, audio, visual, or another type of input) from UE 102 and transmit them to a VMI server. At private network 104, the VMI server may receive the sensor input transmitted from UE 102 and use the input to select and launch a local application, run the application locally, interact with the application, and/or select and terminate the application on the VMI server. In such embodiments, the VMI client and VMI server (herein collectively referred to as the VMI) segregate the data on UE 102 and/or other applications on UE 102 from the data and/or the applications on private network 104. The segregation may further secure private network 104 from UE 102.

Secure space 106 may encompass a geographical region or a 3D region. In one implementation, the MNO of private network 104 may establish secure space 106 by remote installation and configuration of a secure space application on UE 102, so that UE may recognize the boundaries of secure space 106. The configuration may be performed from within private network 104 or from within another network, for example, via Mobile Device Manager (MDM), an over-the-air (OTA) server, etc. Once configured, the secure space application on UE 102 may detect the location of UE 102 in relation to secure space 106.

To aid UE 102 to determine its location, secure space 106 may include beacons 209-1, 209-2 . . . and 209-R, where R is an integer greater than 1 (herein collectively referred to as beacons 209 and generically as beacon 209). Each of beacons 209 (e.g., Bluetooth® Low Energy (BLE) beacons) may transmit signals, which UE 102 may use in conjunction with timing signals from GPS satellites to determine its location. In some implementations, although UE 102 includes a GPS receiver, the location information supplied by the GPS receiver alone may not provide sufficient level of precision to UE 102 for UE 102 to determine whether UE 102 is in secure space 106.

As further shown, secure space 106 may include one or more access node 210. Access node 210 may comprise a base station, a Closed Subscriber Group-enabled base station (to be described below), a Wi-Fi® device, a Fixed Wireless Access (FWA) device, a Customer Premises Equipment (CPE) device, or another type of device with the capability to connect devices in secure space 106 to private network 104.

For example, if access node 210 is implemented as a Closed Subscriber Group (CSG)-enabled base station (also referred to as a CSG access device or sometimes simply as a base station), access node 210 may allow UE 102 to connect to network 104 by attaching to the base station but may also limit UE access to the base station resources based on the CSG to which UE 102 belongs. Examples of CSG access devices include small cells, such as femtocells.

For example, when access node 210 is implemented as a femtocell, access node 210 may broadcast CSG-related parameters within secure space 106. CSG parameters may include a CSG identifier (ID) and a CSG mode. When UE 102 detects the CSG parameters in the broadcast signal from access node 210, UE 102 may determine, based on the CSG parameters, whether to connect to private network 104. In some implementations, when UE 102 requests a connection to core network 206, access node 210 may relay the request to core network 206. In addition to authenticating UE 102, core network 206 may also verify that UE 102 is a member of a CSG by looking up the subscription information (e.g., compare the CSG ID in the request to a CSG ID in the subscription information), before permitting UE 102 to establish the requested session.

A CSG mode may include Open, Closed, and Hybrid. If a CSG, whose ID and mode are specified in a System Information Block type 1 (SIB1) transmitted by access node 210, is in the Open mode, the base station may avail its resources to any UE 102 attaching to the base station and accessing networks through the base station. If a CSG is in the Closed mode, the base station may provide its resources only to high-priority UEs 102 (also referred to as preferred UEs 102)—UEs that belong to the CSG. If the CSG is in the Hybrid mode, the base station may provide its resources to any UE 102 attached to the base station, with the proviso that, if there is a contention, between a preferred UE 102 (e.g., UE 102 that belongs to the CSG) and a non-preferred UE 102, for base station resources, the preferred UE 102 may preempt the non-preferred UE 102. That is, the base station may permit the preferred UE 102 to access the resources and prevent the non-preferred UE 102 from accessing the resources.

Access network 204 may allow UE 102 to access core network 206. To do so, access network 204 may establish and maintain, with participation from UE 102, an over-the-air channel with UEs 102; and maintain backhaul channels with core network 206. Access network 204 may relay information through such channels, from UE 102 to core network 206 and vice versa. Access network 204 may include an LTE radio network and/or a 5G NR network, or another advanced radio network. These networks may include many central units (CUs), distributed units (DUs), radio units (RUS), and wireless stations for maintaining over-the-air channel with UE 102. These components, herein referred to as access stations, may include a 4G, 5G, or another type of base station (e.g., access node 210, eNB, gNB, etc.) that comprises one or more RF transceivers. In some implementations, the access station may be part of an evolved Universal Mobile Telecommunications Service (UMTS) Terrestrial Network (eUTRAN).

As further shown, access network 204 may include one or more Multi-Access Edge Computing clusters (MEC) 212, Each MEC 212 may include MEC devices arranged to provide redundancy. Each MEC device may be coupled to an access station (e.g., eNB, gNB, or other RAN devices such as CU, DU, etc.). Because of its proximity to an access station and therefore its proximity to UEs 102 attached to the access station via wireless communication links, the MEC devices may provide services to UEs 102 with minimal latency.

As depicted in FIG. 2, MEC 212 (or MEC devices in MEC 212) may host Secure Space Support System (SSSS) 214. SSSS 214 may service UEs 102 that are attached to private network 104 via access node 210. After UE 102 attaches to private network 104, UE 102 may establish a session with SSSS 214 via particular types of sessions, such as a web Real Time Communication (WebRTC) sessions. Thereafter, a VMI client on UE 102 may obtain services via a VMI server hosted by SSSS 214 over the established session. In other implementations, SSSS 214 may be hosted on other parts of private network 104, such as core network 206 or data network 208.

Core network 206 may manage communication sessions of UEs 102 connecting to private network 104 via access network 204. For example, core network 206 may establish an Internet Protocol (IP) connection between UEs 102 and MECs 212 in access network 204, core network 206, or data networks 208. In some implementations, core network 206 may include a 5G core network. In other implementations, core network 206 may include a 4G core network (e.g., an evolved packet core (EPC) network) or another type of core network.

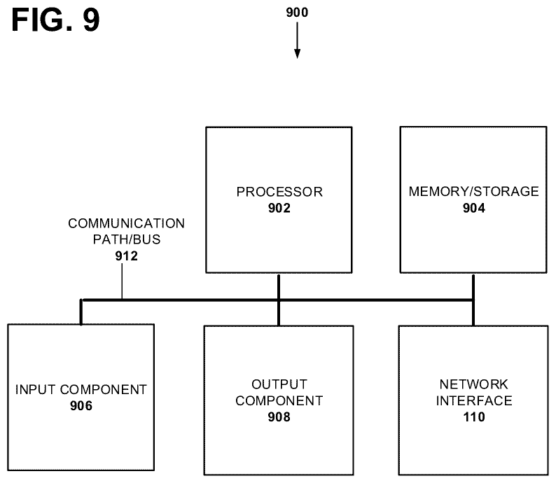

The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a Virtual Network Function (VNF) virtual machine, a container, an event driven server-less architecture interface, and/or another type of SDN component. The common shared physical infrastructure may be implemented using one or more devices 900 described below with reference to FIG. 9.

As further shown, core network 206 may include a Mobile Device Management system (MDM) 216 and Access Node Control (ANC) 218. MDM 216 may manage a set of UEs 102. For example, MDM 216 may perform software and/or data administration functions on UEs 102, such as installing, removing, or updating software and/or data on UEs 102, or configuring UEs 102 (e.g., change device settings, etc.). ANC 218 may administer access nodes 210. For example, assuming that access nodes 210 are implemented as CSG access devices (e.g., small cells, femtocells, etc.), ANC 218 may specify CSG modes for access nodes 210. Depending on the implementation, MDM 216 and ANC 218 may be hosted on other portions of private network 104, such as data network 208 or MEC 212.

Data networks 208 each may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communication with a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also simply referred to as application). An application may provide services for a program or an application running on UEs 102 and may establish communication sessions with UEs 102 via core network 206.

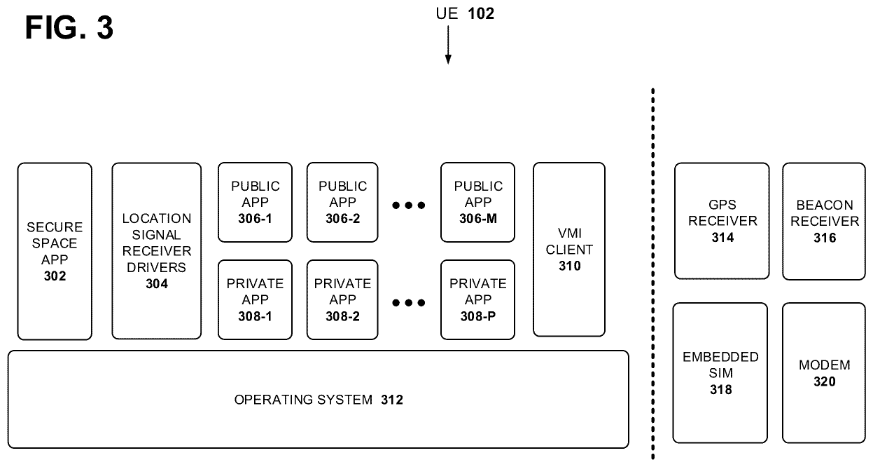

In FIG. 2, UE 102, access network 204, core network 206 and/or data networks 208 may include one or more components of system 100 for securing UE 102 communications in one or more of secure space 106. System 100 may comprise, for example, secure space UEs 102, MEC devices 212, SSSS 214, MDM 216, ANC 218, and/or other portions of access network 204, core network 206, and/or data network 208. Some of these components are described in greater detail with reference to FIGS. 3-9.

For clarity, FIG. 2 does not show all components that may be included in network environment 200 (e.g., routers; bridges; wireless access points; additional networks; additional UEs 102, SSSSs 214, MDMs 216, and/or ANCs 218; MECs 212; etc.). Depending on the implementation, network environment 200 may include additional, fewer, different, or a different arrangement of components than those illustrated in FIG. 2. Furthermore, in different implementations, the configuration of network environment 200 may be different.

FIG. 3 depicts an exemplary components of UE 102 according to an implementation. As shown, UE 102 may include a secure space application 302, location signal receiver drivers 304, public applications 306-1 through 306-M (collectively public applications 306), private application 308-1 through 308-P (collectively private applications 308), a VMI client 310, an operating system 312, a GPS receiver 314, a beacon receiver 316, an embedded Subscriber Identity Module (SIM) 318, and a modem 320. Although UE 102 may include additional or different functional components than those shown in FIG. 3, for clarity, they are not illustrated in FIG. 3.

Secure space application 302 may be configured to run continuously (e.g., in the background) to determine whether UE 102 is within secure space 106 based on information from various location signals that UE 102 receives and data that defines secure space 106. For example, secure space application 302 may receive location information via location signal receiver drivers 304. Based on the location information, secure space application 302 may manage other applications on UE 102.

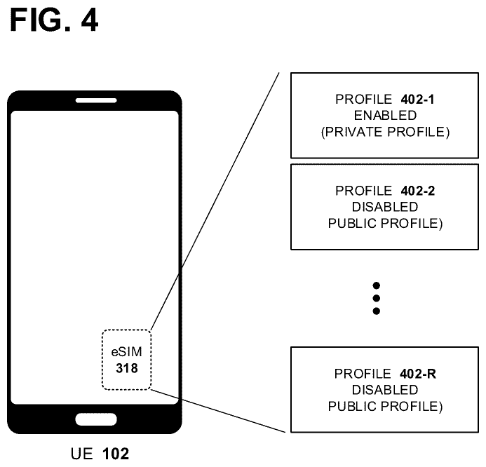

For example, when secure space application 302 determines that UE 102 has just entered secure space 106, secure space application 302 may disable UE 102's public communication (e.g., communications with or via a public cellular network) and enable private communication (e.g., communication with or via private network 104). For example, secure space application 302 may disable or deactivate a user profile, which is associated with a public network and stored in embedded SIM 318; and enable or activate a user profile, which is associated with private network 104 and stored in embedded SIM 318. FIG. 4 illustrates exemplary user profiles that are stored in a secure space UE 102, according to an implementation. As shown, embedded SIM 318 may include profiles 402-1 through 402-R. Profile 402-1 may be associated with private network 104 and be used by UE 102 to connect to private network 104. Profile 402-2 may be associated with a public network and be used by UE 102 to connect to the public network. When UE 102 enters secure space 106 and secure space application 302 detects UE 102's entry into secure space 106, secure space application 302 may enable profile 402-1 and disable profile 402-2. When UE 102 exits secure space 106, secure space application 302 may then disable profile 402-1 and enable profile 402-2.

In addition, when secure space application 302 detects UE 102's entry into secure space 106, secure space application 302 may shut down public applications 306 that are running on UE 102 and disallow them from further execution as long as UE 102 is in secure space 106. Furthermore, secure space application 302 may enable private applications 308 (e.g., display their icons on a menu, start certain services, etc.) and/or run private applications 306. In addition, secure space application 302 may start (or resume) VMI client 310.

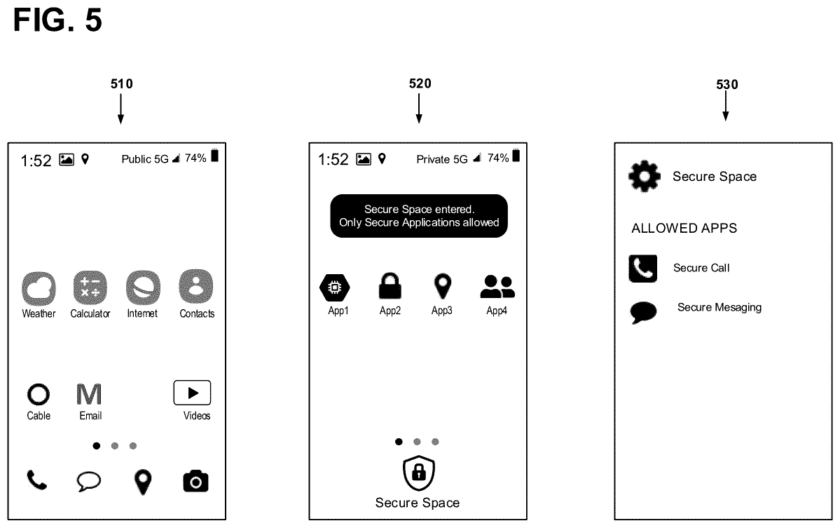

FIG. 5 shows exemplary views 510, 520, and 530 of the display screen of a secure space UE 102 when UE 102 enters secure space 106. As depicted, just prior to the entry, view 510 of the UE display screen shows icons of public applications 304 and services that are available on UE 102. Upon UE 102 entry into secure space 106, secure space application 302 causes UE 102 to display view 520, where the screen shows icons for private applications 306. The user of UE 102 may then navigate to the communication application screen, shown in view 530. In view 530, the UE screen shows icons, displayed by VMI client 310, for secure calls and secure messaging. The user of UE 102 may access and use the secure call application and the secure messaging application, which are hosted on private network 104, via VMI client 310, as explained below.

Referring again to FIG. 3, location signal receiver drivers 304 may include one or more components for enabling various other components on UE 102 to obtain location signal information from location signal receivers, such as a GPS receiver 314 and beacon receiver 316. Public applications 306 may include applications that UE 102 may run when UE 102 is outside of secure space 106. Examples of public applications 306 include applications that use a public network: a messaging application; a phone application; a content application; I/O applications for transmitting or receiving information from another device, such as a storage device; and an email application. Execution of public applications 306 may be either terminated or suspended by secure space application 302 and operating system 312 when UE 102 enters secure space 106. In some implementations, public applications 306 may become reenabled to run or resume their execution when UE 102 exits secure space 106.

Private applications 308 include applications that may run on UE 102 when UE 102 is within secure space 106. Private applications 308 may have been certified as secure by the MNO of private network 104 prior to their installation on UE 102. Secure space application 302 may or may not disable private applications 308 when UE 102 exits secure space 106. In some implementations, an application on UE 102 may be both a public application 306 and a private application 308. Such applications may not be shut down or restarted as a consequence of UE 102 entering or exiting secure space 106.

VMI client 310 may include an application that permits users to activate and run applications that are hosted on virtual machines of SSSS 214. When VMI client 310 launches, VMI client 310 may display a screen view of the icons of applications hosted by the virtual machine of SSSS 214. VMI client 310 streams any user input (e.g., a touch screen tap, voice command, etc.) to the VMI server, which then converts the streamed input into commands for the applications hosted on the virtual machine. When the VMI server receives any output from the hosted applications, the VMI server streams the output to VMI client 310. VMI client 310 then converts the received output stream into images on the screen or sounds through UE speakers. VMI client 310 does not execute any client code for the applications hosted on the virtual machine. Furthermore, no data on UE 102 is sent directly to the hosted applications through VMI client 310.

Operating system 312 may manage resources (e.g., processing cycles, memory, storage, cores, etc.) and execution of various programs and scripts on UE 102. Operating system 312 may provide a set of system services and APIs through which applications on UE 102 may obtain services of other components on UE 102. For example, via operating system 312, secure space application 302 may invoke location signal receiver drivers 304 or VMI client 310.

GPS receiver 314 may receive GPS signals from GSP satellites and provide timing signal information to another component on UE 102 via location signal receiver drivers 304. Similarly, beacon receiver 316 may receive beacon signals from beacons 209 and provide the signal information to another component in UE 102 via location signal receiver drivers 304. In one implementation, the beacon receivers 316 may be implemented as a Bluetooth Low Energy (BLE) receivers.

Embedded SIM 318 may include embedded subscriber identity modules. In contrast to a removable SIM, which may include only one user profile, embedded SIM 318 may include multiple user profiles, each for a different network. As discussed above, embedded SIM 318 may include user profiles for private network 104 and/or public networks. Modem 320 may perform communication-related functions, including establishing connections between UE 102 and another network (e.g., a public network, private network 104, etc.), delivering messages form/to UE 102 to/from a network, perform modulation/demodulation, perform signal processing, apply UE Route Selection (URSP) rules, etc.

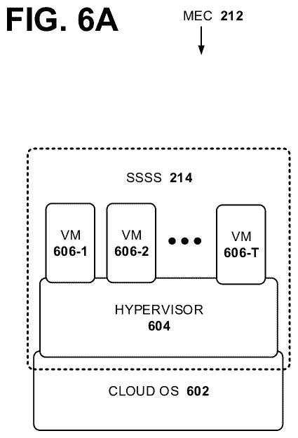

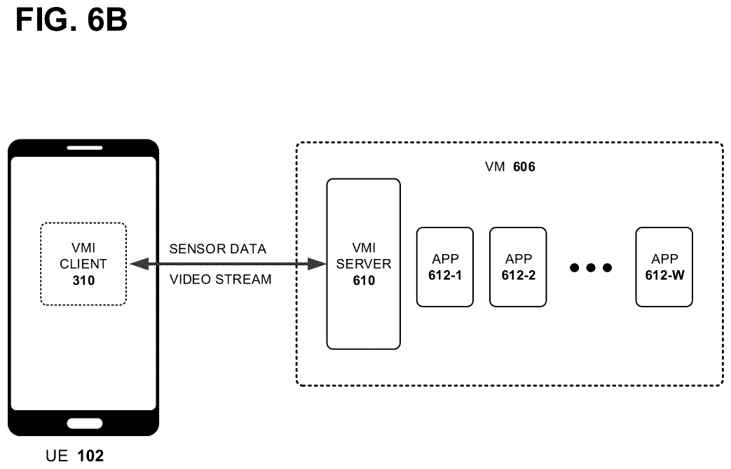

FIG. 6A illustrates exemplary components of SSSS 214 according to an implementation. As shown, SSSS 214 may be implemented on MEC 212 and may comprise a cloud OS 602, a hypervisor 604, and virtual machines 606-1 through 606-T. Depending on the implementation, SSSS 214 may include additional or different components than those illustrated in FIG. 6A.

Cloud OS 602 may include software components for managing MEC 212 as part of access network 204 and private network 104. Cloud OS 602 may provide network OS services to components of MEC 212. Hypervisor 604 may manage virtual machines 606. Although hypervisor 604 is shown as being implemented on cloud OS 602, in other implementations, hypervisor 604 may be implemented directly on top of MEC devices 212. Hypervisor 604 may create, terminate, and/or suspend virtual machines 606. Virtual machines 606 may emulate individual computers. Virtual machines 606 may host VMI servers and applications. According to one implementation, each virtual machine 606 may correspond to a virtualized execution environment of a single UE 102.

FIG. 6B depicts exemplary components of virtual machine (VM) 606, according to an implementation. As shown, virtual machine 606 may include VMI server 610 and applications 612-1 through 612-W. Although virtual machine 606 may include other components, for clarity, they are not illustrated in FIG. 6B. VMI server 606 may include a program configured to operate as a low-level interface between VMI client 310 and applications 612. After a session between VMI client 310 on UE 102 and VMI server 610 is established over, for example, a WebRTC connection, VMI client 310 may send input sensor data over the session to VMI server 610. When VMI server 610 receives the input, VMI server 610 provides the sensor data to the local operating system (not shown). That is, VMI server 610 behaves as if it were a local hardware input device (e.g., a touch screen, a microphone, etc.) by providing the received input from VMI client 310 and funneling them to the local operating system. The local operating system then distributes the input to a target application 612. When application 612 generates an output, the local operating system directs the output to VMI server 610. VMI server 612 then forwards the output to VMI client 310 as low-level hardware output (e.g., an image, an acoustic signal, etc.) over the session. To the user of UE 102, VMI client 310, VMI server 610, and applications 612 behave as if applications 612 were running on UE 102. However, as clear from FIG. 6B and the preceding description, applications 612 execute on virtual machine 606 of SSSS 214 on MEC 212. Since applications 612 all run within private network 104, no data (other than sensor data) moves between UE 102 and private network 104 due to the execution of applications 612-providing an additional layer of protection to private network 104.

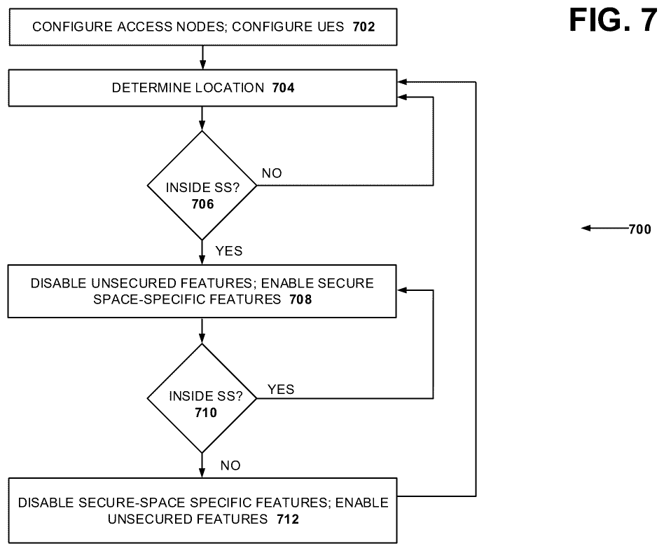

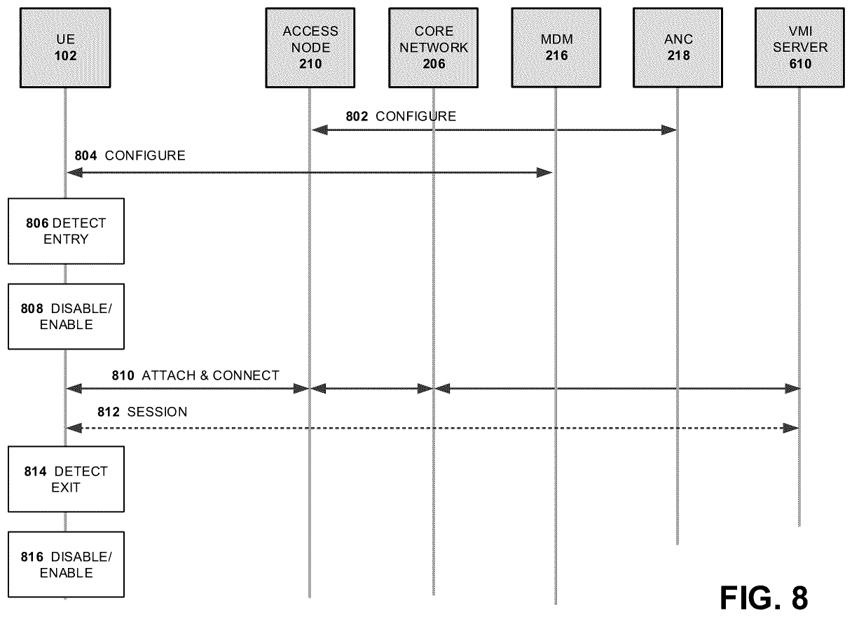

FIG. 7 is a flow diagram of an exemplary process 700 that is associated with system 100 according to an implementation. FIG. 8 is a messaging diagram that is associated with system 100 during process 700. Process 700 is described below with reference to both FIG. 7 and FIG. 8. As shown, process 700 may include configuring one or more of access node 210 (block 702) and configuring UEs 102 (block 702). For example, assume that UEs 102 have been assigned a CSG ID of X (e.g., X=a positive integer or an alphanumeric string). Prior to securing communications in secure space 106, ANC 218 may configure access nodes 210 by sending control signals/messages (arrow 802) to access nodes 210. The messages may cause access nodes 210 to have a CSG with the ID of X. When UEs 102 with the CSG ID of X attempts to attach to access node 210, access node 210 may permit the UE 102 to attach to access node 210 and attempt to connect to private network 104. UEs 102 with different CSG ID may not be allowed to attach to access node 210.

In another example, MDM 216 in private network 104 may configure UEs 102 (arrow 804). MDM 216 may send commands that result in installation of private applications 308, removal of applications that have not been certified as secure, installation of secure space application 302, installation of device drivers, installation of VMI client 310, etc. In addition, MDM 216 may provide secure space information to UEs 102 so that secure space applications 302 on UEs 102 can use the secure space information and their host UEs 102's current coordinates (i.e., information that describes UEs 102's current locations) to determine whether UEs 102 are within secure space 106. In some implementations, MDM 216 may cause user profiles (e.g., profiles associated with accessing and using private network 104) to be installed on embedded SIMs 318 of UEs 102.

Assume that one of the UEs 102 is outside of secure space 106. After the UE 102 is configured to operate as a secure space UE 102 and the UE 102 is powered up, the UE 102 may run secure space application 302 continuously in the background. Furthermore, secure space application 302 may continually determine the location of its host UE 102 and determine whether it is inside or outside of secure space 106.

Accordingly, process 700 may further include the UE 102 determining its current location (block 704). For example, secure space application 302 may determine the location of UE 102 based on GPS signals and/or beacon signals. Furthermore, based on the determined location, secure space application 302 may determine whether the UE 102 is inside of secure space 106 (block 706). If UE 102 detects that it is not inside secure space 106 (block 706: NO), process 700 may return to block 704. Otherwise (block 706-YES; block 806), process 700 may proceed to block 708.

Process 700 may further include UE 102 disabling features that are unsecured (features that the MNO of private network 104 has not certified as secure) and enabling secure space-specific features (block 708; block 808). For example, UE 102 may disable: certain I/O functions of UE 102, such as functions for writing to an external drive using a Universal Serial Bus (USB) or scanning data; UE 102's ability to communicate wirelessly with Wi-Fi® devices or other external devices; public applications 306 that have not been secured; its ability to communicate with a public network (e.g., disable a user profile, in embedded SIM 318, that is associated with the public network); etc. If UE 102 were attached to a public network and were conducting a session with the public network, the UE 102 may terminate the session and detach from the public network.

In addition, UE 102 may enable: UE 102's ability to communicate with private network 104 (e.g., enable a user profile, in embedded SIM 318, that is associated with private network 104); private applications 308; VMI client 310; and/or other I/O functions specific for secure space 106; etc. UE 102 may not need to disable or enable features that are deemed secure when UE 102 enters secure space 106.

When UE 102 is inside of secure space 106, UE 102 may not only run secure applications or use secure UE features, but also connect to private network 104 (arrows 810). Establishing the connection may entail, for example, attaching to access node 210, authenticating at core network 206, and establishing a session (arrow 812) between VMI client 310 on UE 102 and VMI server 610 on virtual machine 606 of SSSS 214. After the establishing the session, the user of UE 102 may access applications hosted on virtual machine 606 via VMI client 310 and VMI server 610. As described above, these applications are shielded from direct data transfer from UE 102 and/or applications 306 and 308 that run locally on UE 102.

Process 700 may further include the UE 102 detecting when UE 102 is no longer inside secure space (block 710)—with secure space application 302 running continuously to determine the location of UE 102 and determine whether UE 102 is inside secure space 106. If UE 102 is inside secure space 106 (block 710: YES), process 700 may return to block 708. Otherwise (block 710: NO and block 814), process 700 may proceed to block 712 (also block 816), where UE 102 may reverse the process performed at blocks 708 and 808. That is, the UE 102 may enable the features that are unsecured (the features disabled at blocks 708 and 808) and disable secure space-specific features (the features enabled at blocks 708 and 808).

FIG. 9 depicts example components of a network device 900. UE 102, beacons 209, access node 210, access network 204, core network 206, data networks 208, MEC devices in MEC 212, and/or other elements in network 104 (e.g., routers, bridges, gateways, servers, switches, etc.) may include or be implemented by or implemented on one or more of network device 900. As shown, network device 900 includes a processor 902, memory/storage 904, an input component 906, an output component 908, a network interface 910, and a communication path 912 (or bus 912). In different implementations, network device 900 may include additional, fewer, different, or a different arrangement of components than the ones illustrated in FIG. 9. For example, network device 900 may include a display, network card, etc.

Processor 902 may include a processor, a microprocessor, an Application Specific Integrated Circuit (ASIC), a Field Programmable Gate Array (FPGA), a programmable logic device, a chipset, an application specific instruction-set processor (ASIP), a system-on-chip (SoC), a central processing unit (CPU) (e.g., one or multiple cores), a microcontrollers, and/or another processing logic device (e.g., embedded device) capable of controlling device 900 and/or executing programs/instructions.

Memory/storage 904 may include static memory, such as read only memory (ROM), and/or dynamic memory, such as random access memory (RAM), or onboard cache, for storing data and machine-readable instructions (e.g., programs, scripts, etc.). Memory/storage 904 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 904 may be external to and/or removable from network device 900.

Memory/storage 904 may also include, for example, a Universal Serial Bus (USB) memory stick, a dongle, a hard disk, off-line storage, a Blu-Ray® disk (BD), etc.

Depending on the context, the term “memory,” “storage,” “storage device,” “storage unit,” “computer-readable medium,” “non-transitory computer-readable medium,” and/or “medium” may be used interchangeably. For example, a “computer-readable storage device” or “computer-readable medium” may refer to both a memory and/or storage device.

Input component 906 and output component 908 may provide input and output from/to a user to/from device 900. Input and output components 906 and 908 may include, for example, a display screen, a keyboard, a mouse, a speaker, actuators, sensors, gyroscope, accelerometer, a microphone, a camera, a DVD reader, Universal Serial Bus (USB) lines, and/or other types of components for obtaining, from physical events or phenomena, to and/or from signals that pertain to device 900.

Network interface 910 may include a transceiver (e.g., a transmitter and a receiver) for network device 900 to communicate with other devices and/or systems. For example, via network interface 910, network device 900 may communicate with a base station. Network interface 910 may include an Ethernet interface to a LAN, and/or an interface/connection for connecting device 900 to other devices (e.g., a Bluetooth® interface). For example, network interface 910 may include a wireless modem for modulation and demodulation.

Communication path (or bus) 912 may enable components of network device 900 to communicate with one another.

Network device 900 may perform the operations described herein in response to processor 902 executing software instructions stored in a non-transitory computer-readable medium, such as memory/storage 904. The software instructions may be read into memory/storage 904 from another computer-readable medium or from another device via network interface 910. The software instructions stored in memory or storage (e.g., memory/storage 904, when executed by processor 902, may cause processor 902 to perform processes that are described herein. For example, instructions that are associated with implementing components depicted in FIGS. 1-8 may be executed by one or more of processor 902. When executed by processor 902, the instructions may cause processor 902 to perform functions and processes described above with reference to FIGS. 1-8.

In this specification, various preferred embodiments have been described with reference to the accompanying drawings. Modifications may be made thereto, and additional embodiments may be implemented, without departing from the broader scope of the invention as set forth in the claims that follow. The specification and drawings are accordingly to be regarded in an illustrative rather than restrictive sense. For example, while a series of blocks and arrows have been described above with regard to the processes and messages illustrated in FIGS. 7 and 8, the order of the blocks and arrows may be modified in other implementations. In addition, non-dependent blocks and arrows may represent actions and messages that can be performed and exchanged in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store, or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. A device comprising:
a processor configured to:
determine, based on secure space information, whether the device has entered the secure space;
if it is determined that the device has entered the secure space:
disable an ability of the device to communicate wirelessly with networks other than a private network;
enable an ability of the device to communicate wirelessly with the private network;
connect the device wirelessly to the private network; and
run an application hosted on the private network.

2. The device of claim 1, wherein when the processor determines whether the device has entered the secure space, the processor is configured to:
determine a current location of the device based on external signals; and
determine whether the current location is within an area specified by the secure space information.

3. The device of claim 2, wherein the device further comprises at least one of:
a receiver for receiving external signals from one or more beacons; or
a receiver for receiving external signals from one or more Global Positioning Satellite (GPS) satellites.

4. The device of claim 1, wherein the processor is further configured to:
receive the secure space information of the secure space from a network.

5. The device of claim 1, wherein when the processor disables the ability of the device to communicate with networks other than the private network, the processor is configured to:
disable a user profile stored in an embedded Subscriber Identity Module (SIM) of the device.

6. The device of claim 1, wherein when the processor connects the device to the private network, the processor is configured to:
wirelessly attach the device to an access node that is located within the secure space.

7. The device of claim 6, wherein the access node includes one of:
a Closed Subscriber Group (CSG) base station;
a Customer Premises Equipment (CPE) device; or
a Fixed Wireless Access (FWA) device.

8. The device of claim 1, wherein when the processor connects the device to the private network, the processor is configured to:
establish a session between a Virtual Mobile Infrastructure (VMI) client hosted on the device and a VMI server hosted on a virtual machine running on the private network.

9. The device of claim 8, wherein the session includes a Web Real Time Communication (WebRTC) session.

10. The device of claim 1, wherein the processor is further configured to:
determine, based on the secure space information, whether the device has exited the secure space; and
if it is determined that the device has exited the secure space:
re-enable the ability of the device to communicate with the networks;
disconnect the device from the private network; and
disable the ability of the device to communicate with the private network.

11. A method comprising:
determining, based on secure space information related to a secure space, whether a device has entered the secure space;
if it is determined that the device has entered the secure space:
disabling an ability of the device to communicate wirelessly with networks other than a private network;
enabling an ability of the device to communicate wirelessly with the private network;
connecting the device wirelessly to the private network; and
running an application hosted on the private network.

12. The method of claim 11, wherein determining whether the device has entered the secure space includes:
determining a current location of the device based on external signals; and
determining whether the current location is within an area specified by the secure space information.

13. The method of claim 12, wherein the device further comprises at least one of:
a receiver for receiving external signals from one or more beacons; or
a receiver for receiving external signals from one or more Global Positioning Satellite (GPS) satellites.

14. The method of claim 11, further comprising:
receiving, by the device, the secure space information of the secure space from a network.

15. The method of claim 11, wherein disabling the ability of the device to communicate with networks other than the private network includes:
disabling a user profile stored in an embedded Subscriber Identity Module (SIM) of the device.

16. The method of claim 11, wherein connecting the device to the private network includes:
wirelessly attaching the device to an access node that is located within the secure space.

17. The method of claim 16, wherein the access node includes one of:
a Closed Subscriber Group (CSG) base station;
a Customer Premises Equipment (CPE) device; or
a Fixed Wireless Access (FWA) device.

18. The method of claim 18, wherein the session includes a Web Real Time Communication (WebRTC) session.

19. A non-transitory computer-readable medium comprising processor executable instructions, which, when executed by a processor included in a device, cause the processor to:
determine, based on secure space information related to a secure space, whether the device has entered the secure space;
if it is determined that the device has entered the secure space:
disable an ability of the device to communicate wirelessly with networks other than a private network;
enable an ability of the device to communicate wirelessly with the private network;
connect the device wirelessly to the private network; and
select and run an application hosted on the private network.

20. The non-transitory computer-readable medium of claim 19, wherein when connecting the device to the private network, the processor further configured to:
establish a session between a Virtual Mobile Infrastructure (VMI) client hosted on the device and a VMI server hosted on a virtual machine running on the private network.
